(19) United States
(12) Patent Application Publication
(10) Pub. No.: US 2025/0340037 A1
(43) Pub. Date: Nov. 6, 2025

(54) POLYETHERETHERKETONE (PEEK) HIGH-TEMPERATURE MULTILAYER TUBING

(71) Applicant: GM Global Technology Operations LLC, Detroit, MI (US)

(72) Inventor: Dennis M. D'hondt, Ray, MI (US)

(21) Appl. No.: 18/652,280

(22) Filed: May 1, 2024

(51) Int. Cl. B32B 1/08; B32B 7/12; B32B 27/08; B32B 27/28; B32B 27/30; B32B 37/15; B32B 38/00

(52) U.S. Cl. CPC B32B 1/08; B32B 7/12; B32B 27/08; B32B 27/288; B32B 27/306; B32B 37/15; B32B 38/0004; B32B 38/0012; B32B 2250/04; B32B 2307/306; B32B 2307/7376; B32B 2329/00; B32B 2371/00; B32B 2605/00

(57) ABSTRACT

A multilayer tube for a vehicle, a vehicle including a multilayer tube, and a method of forming a multilayer tube. The multilayer tube includes a liner of polyether ether ketone, which defines a bore in the multilayer tube. The multilayer tube also includes an exterior layer covering the liner. The exterior layer includes at least one polymer selected from a polyamide polymer, a polyphenylene sulfide polymer, a polyamide copolymer, and a polyphenylene sulfide alloy. The multilayer tube exhibits a continuous use temperature of 150 degrees Celsius or greater.

### BACKGROUND

Fluoropolymers, such as perfluoroalkyls and polyfluoroalkyls (PFAS), perfluorooctanoic acids (PFOA), and perfluorooctane sulfonate (PFOS), exhibit a number of useful properties including chemical resistance, thermal/temperature resistance, non-wetting properties, and non-stick properties. Due to these beneficial properties, fluoropolymers have been used in various applications in the automotive industry. Such applications include, for example, fuel lines, fuel hoses, fuel vapor recovery hoses, turbocharger hoses, hydraulic hoses, tubing used in sensors for the exhaust and air intake systems, anti-lock brake system brake lines, and various seals used in the fuel, lubrication, exhaust and intake systems. However, efforts have been made to shift from the use of fluoropolymers in some applications.

Thus, while materials and fluoropolymers presently used in automotive applications achieve their intended purpose, there is a need for new and improved materials and polymers in automotive applications.

### SUMMARY

According to various aspects, the present disclosure relates to a multilayer tube for a vehicle. The multilayer tube includes a liner of polyether ether ketone, which defines a bore in the multilayer tube. The multilayer tube also includes an exterior layer covering the liner. The exterior layer includes at least one polymer selected from a polyamide polymer, a polyphenylene sulfide polymer, a polyamide copolymer, and a polyphenylene sulfide alloy. The multilayer tube exhibits a continuous use temperature of 150 degrees Celsius or greater.

In embodiments of the above, the polyamide polymer is selected from at least one polyamide polymer of the group consisting of polyamide 6-12 (PA612), polyamide 6-10 (PA610), and polyamide 9T (PA9T).

In any of the above embodiments, the multilayer tube exhibits an external diameter in the range of 0.5 centimeter to 3 centimeters and the wall thickness is in the range of 0.6 millimeter to 2.0 millimeters.

In any of the above embodiments, the multilayer tube further includes a first bonding layer connecting the liner and the exterior layer. In embodiments, the first bonding layer includes a polyamide adhesive.

In any of the above embodiments, the multilayer tube further includes a barrier layer between the liner and the exterior layer. The barrier layer exhibits a thickness in the range of 0.05 millimeters to 0.2 millimeters. In embodiments, the barrier layer includes an ethylene vinyl alcohol polymer (EVOH). In additional embodiments, the first bonding layer connects the liner and the barrier layer and a second bonding layer connects the barrier layer and the exterior layer.

In any of the above embodiments, the multilayer tube further includes a structural layer between the liner and the exterior layer. In further embodiments, the structural layer includes at least one of a polyamide polymer, a polyphenylene sulfide polymer, a polyamide copolymer, and a polyphenylene sulfide alloy. In yet further embodiments, the first bonding layer connects the liner and the structural layer and a second bonding layer connects the structural layer and the exterior layer. In yet further embodiments, the multilayer tube further includes a barrier layer between the structural layer and the exterior layer. And in yet further embodiments, the multilayer tube includes a first bonding layer connecting the liner and the structural layer, a second bonding layer connecting the barrier layer and the exterior layer, and a third bonding layer connecting the structural layer and the barrier layer.

According to various additional aspects, the present disclosure relates to a vehicle. The vehicle includes a multilayer tube defining a flow path. In embodiments, the multilayer tube includes the multilayer tube for a vehicle according to any of the embodiments described above. In embodiments, the multilayer tube includes a liner of polyether ether ketone, wherein the liner defines a bore of the multilayer tube. The multilayer tube also includes an exterior layer covering the liner. The exterior layer includes at least one of a polyamide polymer, a polyphenylene sulfide polymer, a polyamide copolymer, and a polyphenylene sulfide alloy. Further, the multilayer tube includes a barrier layer between the liner and the exterior layer. The barrier layer includes an ethylene vinyl alcohol polymer (EVOH). The multilayer tube also includes a structural layer between the liner and the barrier layer. The structural layer includes at least one of a polyamide polymer, a polyphenylene sulfide polymer, a polyamide copolymer, and a polyphenylene sulfide alloy. The multilayer tube yet also includes a first bonding layer connecting the liner and the structural layer, a second bonding layer connecting the barrier layer and the exterior layer, and a third bonding layer connecting the structural layer and the barrier layer.

In any of the above embodiments, the multilayer tube exhibits a continuous use temperature of 150 degrees Celsius tor greater.

In any of the above embodiments, the multilayer tube exhibits an external diameter in the range of 0.5 centimeter to 3 centimeters and the wall thickness is in the range of 0.6 millimeter to 2 millimeters.

In any of the above embodiments, the flow path comprises at least one of a fuel vapor recovery flow path, a fuel flow path, an evaporator purge flow path, an exhaust gas recirculation sensor flow path, a diesel particulate sensor flow path, and a positive crankcase ventilation flow path.

In embodiments of the above, the multilayer tube is connected to a sensor.

According to various additional aspects, the present disclosure relates to a method of forming a multilayer tube. The method includes extruding a liner of polyether ether ketone, wherein the liner defines a bore of the multilayer tube. The method further includes extruding a first bonding layer over the liner, extruding a structural layer over the first bonding layer, extruding a second bonding layer over the structural layer, extruding a barrier layer over the second bonding layer, extruding a third bonding layer over the barrier layer, and extruding an exterior layer over the third bonding layer. The structural layer includes at least one of a polyamide polymer, a polyphenylene sulfide polymer, a polyamide copolymer, and a polyphenylene sulfide alloy. The barrier layer includes an ethylene vinyl alcohol polymer (EVOH). The exterior layer includes at least one of a polyamide polymer, a polyphenylene sulfide polymer, a polyamide copolymer, and a polyphenylene sulfide alloy.

In embodiments of the above, the method includes cutting the multilayer tube to a length and forming the multilayer tube in a form.

### BRIEF DESCRIPTION OF DRAWINGS

The drawings described herein are for illustration purposes only and are not intended to limit the scope of the present disclosure in any way.

FIG. 1 illustrates a vehicle including an internal combustion engine with a number of auxiliary systems including an air intake, exhaust, exhaust gas recirculation, and fuel recovery systems, according to embodiments of the present disclosure.

FIG. 2 illustrates a multilayer tube cross-section, according to embodiments of the present disclosure.

FIG. 3 illustrates a multilayer tube cross-section, according to embodiments of the present disclosure.

FIG. 4 illustrates a multilayer tube cross-section, according to embodiments of the present disclosure.

FIG. 5 illustrates a method of forming a multilayer tube, according to embodiments of the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

In addition, reference is made in specification and claims to “first,” “second,” “third,” etc. These are arbitrary designations intended to be consistent only in the section in which they appear, the summary, brief description of the drawings, the detailed description, the individual claim sets, and the abstract, and are not necessarily consistent between these portions of the application. In that sense, they are not intended to limit the elements in any way and a “second” element labeled as such in the claim may or may not refer to a “second” element labeled as such in the specification. Instead, the elements are distinguishable by their disposition, description, connections, and function.

The present disclosure is related to a multilayer tube for a vehicle including a polyether ether ketone (PEEK) liner. The multilayer tube is used in a number of applications forming flow paths throughout the vehicle. Such applications include, but are not limited to, fuel-vapor recovery tubes, liquid fuel carrying tubes, evaporator purge flow path, differential pressure sensor tubes, exhaust gas regeneration tubes, and positive crankcase ventilation tubes.

As used herein, the term “vehicle” is not limited to automobiles. While the present technology is described primarily herein in connection with internal combustion engine vehicles using a combustible fuel such as diesel, gasoline, biodiesel, or ethanol, it should be appreciated that the multilayer tubes described herein is not limited to internal combustion engine vehicles using combustible fuel, but also hybrid electric vehicles as well. In addition, the concepts can be used in a wide variety of applications, such as in connection with components used in motorcycles, mopeds, locomotives, aircraft, marine craft, and other vehicles, as well as in other applications utilizing motors, such as in portable power stations, such as those used for powering remote job sites, emergency back-up power supplies, and permanent power stations associated with buildings and equipment, all of which may be powered by engines.

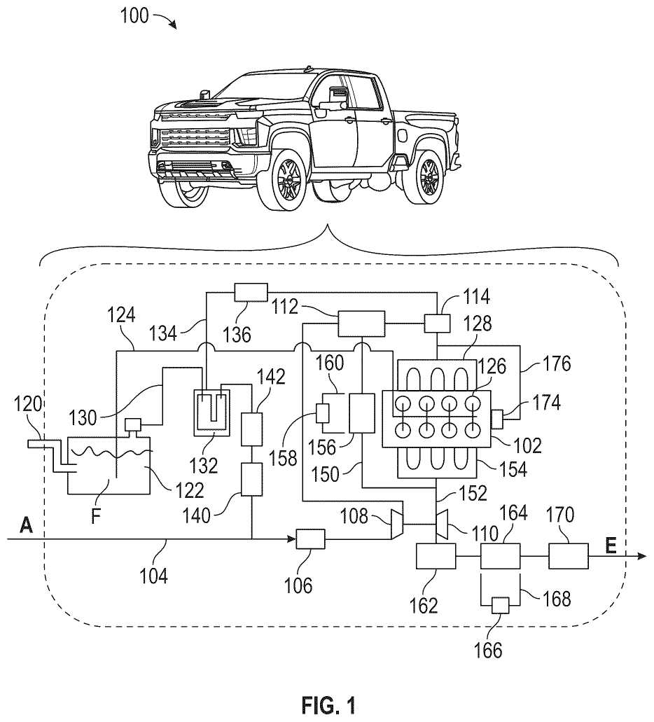

FIG. 1 illustrates a vehicle 100. The vehicle 100 includes an internal combustion engine 102. The internal combustion engine 102 is supplied with air and fuel. Intake air A is supplied through an air intake passage 104. A mass flow air sensor 106 may be provided in the air intake passage 104 to measure the mass flow rate of the air A. In embodiments, the intake air A is then compressed in a compressor 108 of a turbocharger, if present, which turbine 110 is driven by exhaust gas E. The intake air A may then pass through an intercooler 112 to regulate the temperature of the compressed intake air A. The intake air A then passes through an air intake throttle valve 114.

The fuel system includes a fuel filler pipe 120, which introduces fuel F into the fuel tank 122. Fuel F from the fuel tank 122 is introduced into the internal combustion engine 102 through a fuel line tube 124. The fuel filler pipe 120 and the fuel line tube 124 each define a fuel flow path. In embodiments, the fuel F may be introduced directly into the combustion cylinders 126, or the fuel F may be mixed with the intake air A prior in the intake manifold 128 in alternative embodiments.

The fuel system also includes an evaporation emission system including a fuel vapor recovery flow path. The fuel vapor recovery flow path includes fuel vapor recovery tubes 130 that carry fuel vapor from the fuel tank 122 into an evaporation canister 132. Some of the recovered air from the evaporation canister 132 may be introduced through an air passage tube 134 into the air intake passage 104. While it is illustrated that the recovered air passes directly into the throttle valve 114, other arrangements may be used, such as coupling the air passage tubes 134 to the air intake passage 104 before the intercooler 112 or between the intercooler 112 and the air intake throttle valve 114. An evaporator purge valve 136 may be included in the air passage tubes 134 forming an evaporator purge flow path. The evaporation canister 132 may also receive make-up air from the air intake passage 104, or a secondary air source that is fed into the evaporation canister 132. The make-up air may pass through an air filter 140 and a vent valve 142.

The vehicle 100 may also include an exhaust gas recirculation system. The exhaust recirculation system includes an exhaust gas recirculation passage tube 150 that is connected to the exhaust gas passage 152 that is connected to the exhaust gas manifold 154, which receives exhaust gas E from the combustion cylinders 126. In embodiments, one of the combustion cylinders 126 may be a dedicated exhaust gas recirculation cylinder or a portion of the exhaust gas E from all the combustion cylinders 126 may be directed into the exhaust gas recirculation passage tubes 150. The recirculated exhaust gas may pass through an exhaust gas recirculation valve 156 connected in the flow path of the exhaust gas recirculation passage tubes 150. Further, a sensor 158 for measuring the oxygen content of the exhaust gas in the recirculation passage tube 150 may connected to the exhaust gas recirculation passage tube 150 by way of tubes 160 forming an exhaust gas recirculation sensor flow path.

The remaining exhaust gas E passes through the exhaust passage 152 and through the turbocharger turbine 110, if present, and into, in embodiments, a diesel oxidation catalyst 162, which converts particulate matter, hydrocarbons, and carbon monoxide to carbon dioxide and water. Further the exhaust gas E passes through a diesel particulate filter 164 for the removal of particulate form the exhaust gas E stream. A diesel particulate sensor 166 connected to the exhaust passage 152 at either side of the diesel particulate filter 164 to measure the pressure differential across the diesel particulate filter 164. Tubes 168 are used to connect the diesel particulate sensor 166 to the exhaust passage 152 forming a diesel particular sensor flow path. The exhaust gas E may then pass through a selective catalytic reduction system 170 to convert nitrogen oxides into diatomic nitrogen and water using reductants.

Further, a positive crankcase ventilation system may be included. The positive crankcase ventilation system exhausts vapors from the crankcase through a positive pressure crankcase ventilation valve 174 and a positive crankcase ventilation tube 176 and back into the intake manifold 128. The positive crankcase ventilation tube 176 forms a positive crankcase ventilation flow path. While it is illustrated that the positive crankcase ventilation tube 176 is coupled after the air intake throttle valve 114, it may be coupled in any number of locations in the air intake passage 104.

The various tubes described above provide flow paths including at least one of a fuel vapor recovery flow path, a fuel flow path, an evaporator purge flow path, an exhaust gas recirculation sensor flow path, a diesel particulate sensor flow path, and a positive crankcase ventilation flow path may be formed from the polyether ether ketone lined multilayer tubes described herein. For example, the fuel line tube 124, the tube 168 used to connect the diesel particulate sensor 166, the fuel vapor recovery tubes 130, the tubing 160 connecting the sensor 158 in the exhaust gas regeneration system to the exhaust gas recirculation passage 150, portions of the exhaust gas recirculation passage 150, and the positive crankcase ventilation tube 176, as well as other components may be formed from the polyether ether ketone lined multilayer tubes described herein.

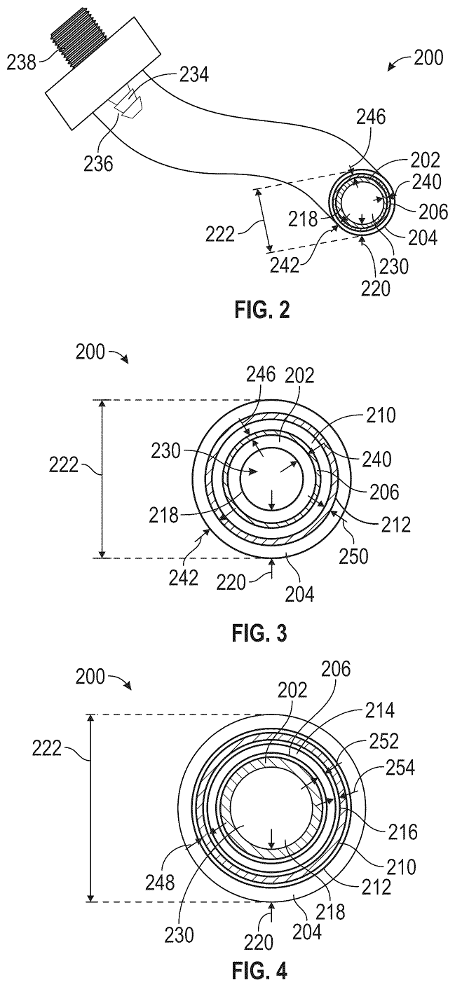

Generally, as illustrated in FIGS. 2 through 4, the polyether ether ketone lined multilayer tubes 200 for use in the applications noted above include a liner 202 of a polyether ether ketone polymer and an exterior layer 204 of a thermoplastic polymer including at least one of a polyamide polymer, a polyphenylene sulfide polymer, a polyamide copolymer, and a polyphenylene sulfide alloy. In embodiments, the polyamide polymer includes at least one of polyamide 9T—a polyamide derived from terephthalic acid and nonanediamine, polyamide 6-12—a polyamide formed from hexamethylenediamine and dodecanedioic acid, and polyamide 6-10—a polyamide formed from the polymerization of hexamethylene diamine with sebacic acid. The polyphenylene sulfide polymer may be linear or branched. Polyamide copolymers include, for example, polyamide-imide copolymers and polyphthalamide. Polyphenylene sulfide alloys include, for example, polyphenylene sulfide—acrylonitrile butadiene styrene alloys, polyphenylene sulfide—polyamide alloys, polyphenylene sulfide—polypropylene alloys, and polyphenylene sulfide—polycarbonate alloys.

The liner 202 forms the interior-most layer and the inner surface 218 of the liner 202 defines the bore 230 of the multilayer tube 200. The exterior layer 204 is located at the exterior of the multilayer tube 200 and covers the liner 202, which is located at the interior of the multilayer tube 200. Optionally, bonding, barrier, and structural layers may also be included in the multilayer tubes 200. The various polymers, including the polyether ether ketone, polyamide, polyphenylene sulfide, polyamide copolymers, polyphenylene sulfide alloys, bonding material, barrier, and structural layer polymers are described further herein.

FIG. 2 illustrates an embodiment in which a multilayer tube 200 includes a liner 202 of the polyether ether ketone polymer and the exterior layer 204. In addition, an optional first bonding layer 206 is provided between the liner 202 and the exterior layer 204. In the illustrated embodiment, the first bonding layer 206 couples the polyether ether ketone polymer liner 202 to the exterior layer 204. However, it should be appreciated that the first bonding layer 206 may be omitted in various applications.

FIG. 3 illustrates another embodiment of the present disclosure, wherein a barrier layer 210 is included between the liner 202 and the exterior layer 204. The barrier layer 210 is understood to prohibit the passage of gasses, such as fuel vapor, through the tube wall. Thus, prohibiting or minimizing, for example, water vapor from entering the multilayer tube 200 or fuel vapor from exiting the multilayer tube 200. In embodiments, the barrier layer 210 includes ethylene vinyl alcohol (EVOH). As illustrated, the first bonding layer 206 is present between the liner 202 and the barrier layer 210 and a second bonding layer 212 is present between the barrier layer 210 and the exterior layer 204. Either one or both of the first bonding layer 206 and the second bonding layer 212 may be omitted depending on the application. The provision of the barrier layer 210, first bonding layer 206, and second bonding layer 212 allows use of the multilayer tube 200 for applications where fuel containing fluids (gasses or liquids) may be introduced into the multilayer tube 200, such as in the fuel vapor recovery tubes 130.

Turning now to FIG. 4, illustrating another embodiment of the present disclosure, a structural layer 214 is included between the liner 202 and the barrier layer 210. The structural layer 214 is understood as a layer that provides additional mechanical support and may assist, in embodiments, in bonding polyether ether ketone of the liner 202 to the exterior layer 204 when bonding layers are not present or may function as a backing to support the liner 202. As illustrated, the first bonding layer 206 is present connecting the liner 202 and the structural layer 214, the second bonding layer 212 is present connecting the exterior layer 204 and the barrier layer 210, and a third bonding layer 216 is present connecting the structural layer 214 and the barrier layer 210. Either one or all of the first bonding layer 206, the second bonding layer 212, and the third bonding layer 216 may be omitted depending on the application. It should be appreciated that in embodiments, the barrier layer 210 may be omitted. In such embodiments, the multilayer tube 200 includes a structural layer 214 between the liner 202 and the exterior layer 204. The first bonding layer 206 is present connecting the liner 202 and the structural layer 214, and the second bonding layer 212 is present connecting the exterior layer 204 and the structural layer 214.

In any of the above described embodiments, the polyether ether ketone liner 202 exhibits a wall thickness 240 in the range of 0.1 millimeters to 0.5 millimeters, including all values and ranges therein. Further, the polyether ether ketone is non-conductive. Alternatively, the polyether ether ketone may include a conductive filler such as one or more of carbon black, graphite, and carbon nanotubes present in an amount to achieve a sufficient conductivity in the polyether ether ketone to allow for its use in the transport of liquid fuel and other nonconductive fluids. In embodiments, the conductive filler may be present in the range of 0.01 percent by weight to 50 percent by weight of the total weight of the polyether ether ketone. In further embodiments, the filler may be dispersed evenly through the polyether ether ketone layer, such that any given volume exhibits a similar percentage by weight of the conductive filler. The conductive fillers are present, for example, when the multilayer tube 200 is present in a fuel filler pipe 120 or used as the fuel line tube 124.

As noted above and in any of the above embodiments, the exterior layer 204 includes at least one of a polyamide polymer, a polyphenylene sulfide polymer, a polyamide copolymer, and a polyphenylene sulfide alloy. The polyamide polymer includes at least one of polyamide 9T—a polyamide derived from terephthalic acid and nonanediamine, polyamide 6-12—a polyamide formed from hexamethylenediamine and dodecanedioic acid, and polyamide 6-10—a polyamide formed from the polymerization of hexamethylene diamine with sebacic acid. The polyphenylene sulfide polymer may be linear or branched. Polyamide copolymers include, for example, polyamide-imide copolymers and polyphthalamide. Polyphenylene sulfide alloys include, for example, polyphenylene sulfide—acrylonitrile butadiene styrene alloys, polyphenylene sulfide—polyamide alloys, polyphenylene sulfide—polypropylene alloys, and polyphenylene sulfide—polycarbonate alloys.

In any of the above embodiments, the structural layer also includes at least one of a polyamide polymer, a polyphenylene sulfide polymer, a polyamide copolymer, and a polyphenylene sulfide alloy The polyamide polymer includes at least one of polyamide 9T—a polyamide derived from terephthalic acid and nonanediamine, polyamide 6-12—a polyamide formed from hexamethylenediamine and dodecanedioic acid, and polyamide 6-10—a polyamide formed from the polymerization of hexamethylene diamine with sebacic acid. The polyphenylene sulfide polymer may be linear or branched. Polyamide copolymers include, for example, polyamide-imide copolymers and polyphthalamide. Polyphenylene sulfide alloys include, for example, polyphenylene sulfide—acrylonitrile butadiene styrene alloys, polyphenylene sulfide—polyamide alloys, polyphenylene sulfide—polypropylene alloys, and polyphenylene sulfide—polycarbonate alloys.

Further, the exterior layer 204, in any of the above embodiments, exhibits a wall thickness 242 in the range of 0.2 millimeters to 1.0 millimeters, including all values and ranges therein (see FIGS. 2 and 3). In embodiments, the structural layer 214 is the same polymer as the exterior layer 204. Alternatively, the structural layer 214 and exterior layer are selected from different polymers of described. Further, the structural layer 214 exhibits a wall thickness 252 in the range of 0.2 millimeters to 1.0 millimeters, including all values and ranges therein (see FIG. 4).

Also as noted above, in any of the above embodiments, the barrier layer 210 includes, in embodiments, EVOH. Alternatively, the barrier layer includes polymer clay composites. Further, the barrier layer exhibits a wall thickness 248 in the range of 0.05 millimeters to 0.2 millimeters, including all values and ranges therein (see FIG. 4).

In any of the above embodiments, the bonding layers, including the first bonding layer 206, the second bonding layer 212, and the third bonding layer 216 include materials that adhere or otherwise unify adjacent layers. Such bonding material may include, for example, thermoplastic adhesives. In embodiments, the bonding material is a plasticizable adhesive, a chemical adhesive, or hot melt adhesive. Non-limiting examples bonding materials include at least one of polyamide and polyolefin adhesives. Polyolefin adhesives include, for example, at least one of low density polyethylene, high density polyethylene and polypropylene. The first bonding layer exhibits a wall thickness 246 in the range of 0.03 millimeters to 0.1 millimeters, including all values and ranges therein (see FIG. 2). The second bonding layer exhibits a wall thickness 250 in the range of 0.03 millimeters to 0.1 millimeters, including all values and ranges therein (see FIG. 3). The third bonding layer 216 exhibits a wall thickness 254 in the range of 0.03 millimeters to 0.1 millimeters, including all values and ranges therein (see FIG. 4).

In any of the above embodiments, the wall thickness 220 of the multilayer tube 200 is in the range of 0.6 millimeters to 2 millimeters, including all values and ranges therein (see FIGS. 2 through 4). Also, in any of the above embodiments, the outer, external diameter 222 of the tube 200 is in the range of 0.5 centimeter to 3 centimeters, including all values and ranges therein, such as in the range of 2.6 centimeters to 2.54 centimeters (see FIGS. 2 through 4). Further, the multilayer tube 200 does not include fluoropolymers.

In embodiments, the flexural modulus of the liner 202 of polyether ether ketone is in the range of 0.1 gigapascals (GPa) to 10 GPa, including all values and ranges therein, the flexural modulus of the exterior layer 204 is in the range of 0.1 GPa to 10 GPa, including all values and ranges therein, and the flexural modulus of the structural layer 214 is in the range of 0.1 GPa to 10 GPa, including all values and ranges therein. In further embodiments, the flexural modulus of the liner 202 is higher than the flexural modulus than the exterior layer 204 and the structural layer 214 (if present). In any of the above embodiments, the thermoplastic composite multilayer tube exhibits a continuous use temperature in the range of 150 or greater, such as in the range of 150 degrees Celsius to 250 degrees Celsius, including all values and ranges therein.

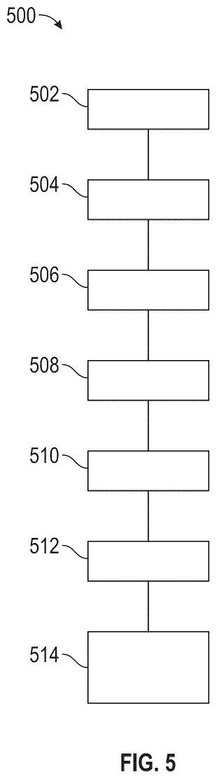

A method of forming the multilayer tubes 200 described herein includes extrusion. As illustrated in FIG. 5, the method 500 includes drying any hygroscopic polymers used to form the multilayer tubes 200 at block 502. At block 504, the various layers of the multilayer tube 200 are extruded using an extrusion process, such as co-extrusion where the layers are formed layer by layer from the interior to the exterior beginning with liner 202 until the exterior layer 204 is formed. Extrusion is understood as a process that utilizes temperature and pressure to cause the polymer materials to exhibit mobility in and between the polymer chains so that the material may deform and assume the shape of an extruder die. In embodiments, up to the seven layers may be co-extruded at the same time or the liner 202 may be formed, allowed to cool and the extruded over, where this process is repeated until all of the layers in the given multilayer tube 200 are formed. Furthermore, during the extrusion process, the thickness of each layer may be controlled by gauges, such as laser gauges or optical gauges.

Upon exiting the extruder the multilayer tube 200 is shaped into a tube. At block 506, the multilayer tube 200 begins cooling. In embodiments, at block 508, the multilayer tube 200 may be cut into lengths or coiled while cooling to provide a general shape to the multilayer tube 200. It should be appreciated that block 508 may occur before block 506, simultaneously with block 506, or after block 506. In further embodiments, the multilayer tube 200 at block 506 is allowed to cool after exiting the extruder and may optionally be cut to length at block 508 after cooling to provide the general shape of the multilayer tube 200. At block 510 springs or other supports are placed into the multilayer tube 200 to prevent kinking and the multilayer tube is placed into a form and may optionally be heated at block 512 to a softening temperature. The softening temperature is understood as a temperature that is at least 20 degrees lower than the melting temperature of the polymer present in the multilayer tube 200 exhibiting the lowest melting temperature. Using the form at block 510 and optionally heating at block 512 allows the multilayer tube 200 to further assume the shape of the form and release stresses that may be present in the material. The springs or supports may then be removed. It should be appreciated that, in embodiments, the multilayer tube 200 may be preheated prior to placing into the form at block 510.

Once the multilayer tube 200 is formed, at block 514, fittings may be added to the multilayer tube 200 to assemble the multilayer tube 200. As the polyether ether ketone liner 202 exhibits a tensile modulus in the range of 0.5 gigapascals (GPa) to 7 GPa, including all values and ranges therein, and a tensile strength in the range of 7 megapascals (MPa) to 50 MPa, including all values and ranges therein, in embodiments, the polyether ether ketone retains press fit connections such as barbed or upset connectors. For example, as illustrated in FIG. 2, a barbed hose fitting 234 may be placed into the bore 230 of the multilayer tube 200. While the barbed hose fitting of FIG. 2 is illustrated as including a plurality of barbs 236 and threads 238, it should be appreciated that other mechanical fittings may be used. Further, the fittings 234 may be integrated into housings. For example, rather than using a barbed hose fitting 234, a sensor housing may include a barbed connector extending therefrom, which may be inserted into the bore 230 of the multilayer tube 200. Alternatively, or additionally, the fittings may be welding to the tubing using a process such as spin welding where the tubing and the mating surface of a plastic fitting are spun relative to one another, which generates heat and bonds the two components relative to one another. The bonded components are then allowed to cool, retaining the bond. Other methods of bonding the tubing to a fitting includes laser welding and ultrasonic welding. In embodiments, the fittings are formed from thermoplastic materials, thermoset materials, metals, or metal alloys.

The multilayer tubing, vehicles including the multilayer tubing, and methods of forming the multilayer tubing exhibit a number of advantages. One such advantage includes the ability to substitute the fluoropolymers noted above with the polyether ether ketone material as liners in the multilayer tubes described herein. Another advantage is that polyether ether ketone exhibits resistance to chemical attack for a broad range of chemically aggressive fluids and gasses, including acids, bases, mineral oils, motor oils, and fuels, including fuels including biodiesel with a relatively high acid and peroxide content. Another advantage is that the multilayer tubes exhibit continuous operating temperatures of 150 degrees Celsius or greater. Yet a further advantage of the multilayer tubing disclosed herein is the chemical resistance exhibited by the polyether ether ketone liner. Another advantage of the presently disclosed multilayer tubes is that the polyether ether ketone exhibits a relatively high tensile modulus retaining press fit connections, such as barbed or upset connectors.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A multilayer tube for a vehicle, comprising:
a liner of polyether ether ketone, wherein the liner defines a bore in the multilayer tube; and
an exterior layer covering the liner, wherein the exterior layer includes at least one polymer selected from a polyamide polymer, a polyphenylene sulfide polymer, a polyamide copolymer, and a polyphenylene sulfide alloy,
wherein the multilayer tube exhibits a continuous use temperature of 150 degrees Celsius or greater.

2. The multilayer tube of claim 1, wherein the polyamide polymer is selected from at least one polyamide polymer of the group consisting of polyamide 612 (PA612), polyamide 610 (PA610), and polyamide 9T (PA9T).

3. The multilayer tube of claim 1, wherein the multilayer tube exhibits an external diameter in the range of 0.5 centimeter to 3 centimeters and the wall thickness is in the range of 0.6 millimeter to 2.0 millimeters.

4. The multilayer tube of claim 1, further comprising a first bonding layer connecting the liner and the exterior layer.

5. The multilayer tube of claim 4, wherein the first bonding layer includes a polyamide adhesive.

6. The multilayer tube of claim 1, further comprising a barrier layer between the liner and the exterior layer, wherein the barrier layer exhibits a thickness in the range of 0.05 millimeters to 0.2 millimeters.

7. The multilayer tube of claim 6, wherein the barrier layer includes an ethylene vinyl alcohol polymer (EVOH).

8. The multilayer tube of claim 6, further comprising a first bonding layer connecting the liner and the barrier layer and a second bonding layer connecting the barrier layer and the exterior layer.

9. The multilayer tube of claim 1, further comprising a structural layer between the liner and the exterior layer.

10. The multilayer tube of claim 9, wherein the structural layer includes at least one of a polyamide polymer, a polyphenylene sulfide polymer, a polyamide copolymer, and a polyphenylene sulfide alloy.

11. The multilayer tube of claim 9, further comprising a first bonding layer connecting the liner and the structural layer and second bonding layer connecting the structural layer and the exterior layer.

12. The multilayer tube of claim 9, further comprising a barrier layer between the structural layer and the exterior layer.

13. The multilayer tube of claim 12, further comprising a first bonding layer connecting the liner and the structural layer, a second bonding layer connecting the barrier layer and the exterior layer, and a third bonding layer connecting the structural layer and the barrier layer.

14. A vehicle, comprising:
a multilayer tube defining a flow path, wherein the multilayer tube includes:
a liner of polyether ether ketone, wherein the liner defines a bore of the multilayer tube,
an exterior layer covering the liner, wherein the exterior layer includes at least one of a polyamide polymer, a polyphenylene sulfide polymer, a polyamide copolymer, and a polyphenylene sulfide alloy,
a barrier layer between the liner and the exterior layer, wherein the barrier layer includes an ethylene vinyl alcohol polymer (EVOH),
a structural layer between the liner and the barrier layer, wherein the structural layer includes at least one of a polyamide polymer, a polyphenylene sulfide polymer, an alloy of a polyamide polymer, and an alloy of a polyphenylene sulfide polymer,
a first bonding layer connecting the liner and the structural layer,
a second bonding layer connecting the barrier layer and the exterior layer, and
a third bonding layer connecting the structural layer and the barrier layer.

15. The vehicle of claim 14, wherein the multilayer tube exhibits a continuous use temperature of 150 degrees Celsius tor greater.

16. The vehicle of claim 14, wherein the multilayer tube exhibits an external diameter in the range of 0.5 centimeter to 3 centimeters and the wall thickness is in the range of 0.6 millimeter to 2 millimeters.

17. The vehicle of claim 14, wherein the flow path comprises at least one of a fuel vapor recovery flow path, a fuel flow path, an evaporator purge flow path, an exhaust gas recirculation sensor flow path, a diesel particulate sensor flow path, and a positive crankcase ventilation flow path.

18. The vehicle of claim 14, wherein the multilayer tube is connected to a sensor.

19. A method of forming a multilayer tube, comprising:
extruding a liner of polyether ether ketone, wherein the liner defines a bore of the multilayer tube;
extruding a first bonding layer over the liner;
extruding a structural layer over the first bonding layer, wherein the structural layer includes at least one of a polyamide polymer, a polyphenylene sulfide polymer, a polyamide copolymer, and a polyphenylene sulfide alloy;
extruding a second bonding layer over the structural layer;
extruding a barrier layer over the second bonding layer, wherein the barrier layer includes an ethylene vinyl alcohol polymer (EVOH);
extruding a third bonding layer over the barrier layer; and
extruding an exterior layer over the third bonding layer, wherein the exterior layer includes at least one of a polyamide polymer, a polyphenylene sulfide polymer, a polyamide copolymer, and a polyphenylene sulfide alloy.

20. The method of claim 19, further comprising cutting the multilayer tube to a length; and
forming the multilayer tube in a form.
